(19) United States
(12) Patent Application Publication
(10) Pub. No.: US 2010/0330289 A1
(43) Pub. Date: Dec. 30, 2010

(54) Method for making high metallic luster, high impedance on flexible polymer based material

(76) Inventors: Chang-Neng Hsiao, Longtan Shiang (TW); Sheng-Kun Huang, Tainan City (TW); Kuo-Lung Tsai, Madou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,041

(22) Filed: Jun. 30, 2009

(51) Int. Cl. B05D 1/36

(52) U.S. Cl. 427/419.1

(57) ABSTRACT

This invention relates to a method for making high metallic luster, high impedance on flexible polymer based material, in which a lustrous layer is coated on the first surface of a flexible polymer based material by means of wet coating and a color protection layer is further coated on the lustrous layer or the second surface of the flexible polymer based material. In this manner, metal-like feeling and luster is enhanced by the lustrous layer such that the flexible polymer based material has low metal shielding effect or light-shield capability. In addition, the transmittance of light and electromagnetic wave in demanded range become better so that the interference on the quality of transmission and receiving can be avoided.

### BACKGROUND OF THE INVENTION

1. Field of the invention

This invention relates to a method for making high metallic luster, high impedance on flexible polymer based material, particularly to a method conducted by coating such that the flexible polymer based material has high impedance, high luster, low metal shielding effect or light-shield capability, and such that the transmittance of light and electromagnetic wave in demanded range become better so as to avoid interference on the quality of transmission and receiving.

2. Brief Description of the Prior Art

Currently, the structure applied in electronic products such as cellular phone, Bluetooth earphone and GPS so as to produce metal-like feeling on the plastic housing of the electronic products and to generate electrostatic shield effect implements the process of vacuum metallization, i.e., so-called NCVM (Non-Conductive Vacuum Metallization). NCVM is the abbreviation of Non-Conductive Vacuum Metallization which belongs to a non-continuos process of Non-Conductive Vacuum Metallization. In currently available NCVM, a metal film layer is overcoated on a plastic based material by vacuum deposition and a non conductive material is combined therewith to serve as the interface layer. As the manufacturing method utilizes the technology of vapor deposition and paint-coating, the final products have non-conductivity and lustrous appearance in accordance with the market demand. If the metal film layer is conductive, interference on transmission or receiving of electromagnetic wave would be happened, needless to say that the structure of lustrous appearance having high impedance and satisfying market demand cannot be produced at the same time. The biggest shortcoming of vacuum deposition technology is that it is not easy to control the evenness of deposition layer thickness. Thus, the processing method of roll-to-roll cannot be satisfied.

Another vacuum metallization process (sputtering) can also make out plastic housing having non-conductive property and lustrous appearance in accordance with market demand, but the shortcoming of the sputtering technology often results in high equipment cost.

### SUMMARY OF THE INVENTION

The main object of this invention is to provide a method for making high metallic luster, high impedance on flexible polymer based material, in which a film layer having high metallic luster, high impedance is formed on flexible polymer based material by coating. So, the flexible polymer based material has high impedance, high luster, Low metal shielding effect or light-shield capability. Moreover, the transmittance of light and electromagnetic wave in demanded range become better so as to avoid interference on the quality of transmission and receiving. Additionally, big size and high speed coating (roll-to-roll) by roller coating method under atmospheric condition can be conducted so that economic value of mass production can be achieved.

In order to achieve above object, this invention provides a method for making high metallic luster, high impedance on flexible polymer based material, in which a lustrous layer is coated on the first surface of a flexible polymer based material by means of wet coating and a color protection layer is further coated on the lustrous layer or the second surface of the flexible polymer based material.

### BRIEF DESCRIPTION OF THE DRAWINGS

FIG. 1 is a view showing the first embodiment of the method for making high metallic luster, high impedance on flexible polymer based material of the present invention.

FIG. 2 is a view showing the second embodiment of the method for making high metallic luster, high impedance on flexible polymer based material of the present invention.

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

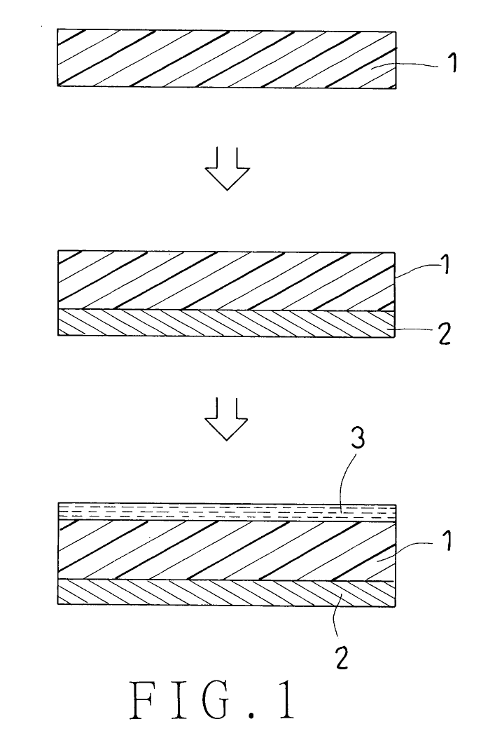

FIG. 1 is a view showing the first embodiment of the method for making high metallic luster, high impedance on flexible polymer based material. In FIG. 1, the manufacturing process is listed as below:

step 1: a flexible polymer based material (1) of predetermined dimension is prepared;

step 2: a layer of metallic luster paint is coated on anyone surface of the flexible polymer based material (1), and then the material is placed within an oven for baking. A lustrous layer (2) is formed on the flexible polymer based material (1) after the coated surface is hardened;

step 3: a color protection layer paint is coated on the surface of the flexible polymer based material (1) without coating to form lustrous layer (2), then the material is placed within an oven for baking to be hardened so as to form the color protection layer (3).

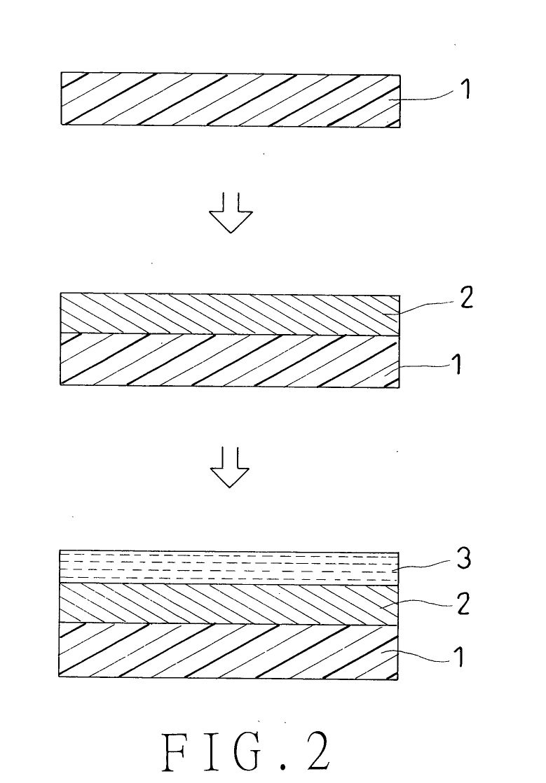

FIG. 2 is a view showing the second embodiment of the method for making high metallic luster, high impedance on flexible polymer based material. In FIG. 2, the manufacturing process is listed as below:

step 1: a flexible polymer based material (1) of predetermined dimension is prepared;

step 2: a layer of metallic luster paint is coated on anyone surface of the flexible polymer based material (1), and then the material is placed within an oven for baking. A lustrous layer (2) is formed on the flexible polymer based material (1) after the coated surface is hardened;

step 3: a color protection layer paint is coated on the lustrous layer (2), and then the material is placed within an oven for baking to be hardened so as to form the color protection layer (3).

The constituents of the metallic lustrous paint are metal and solvent composed of MEK (methyl ethyl ketone), dispersant and thermosetting resin. The metal is composed of at least one or two selected from Sn, In, Al, Ag, Cu, Cr or its compounds. The solid content of metal in the above metallic lustrous layer is 1-5 wt %, preferably 1 wt %. The solid content of resin is 15-20 wt %, preferably 19 wt %. The acid value of the dispersant is 10-20 mgKOH/g, preferably 10 mgKOH/g. In weight percentage, the solid content of dispersant is 10-15 wt %, preferably 10 wt %.

The color protection layer paint is formed by MEK (methyl ethyl ketone) and polymers, paint or hardened resin added with coloring matter or matting powder, in which the solid content of the coloring matter is 10-15 wt %, preferably 10 wt %; the solid content of the resin is 40-60 wt %, preferably 40 wt %.

### Embodiment I

An aluminum foil of dimension 2.5 μm×2.5 μm with 0.5 μm thickness, weight 1 gram is used for preparing the metallic lustrous layer paint. The Al foil is placed in a solvent composed of (A) 70 grams MEK (methyl ethyl ketone), (B) 10 grams dispersant with 10 mgKOH/g acid value, (C) 19 grams thermosetting resin and is conducted with high speed stirring (2000 rpm). Finally, 1 wt % of Al luster layer paint is prepared.

Pink dye is used for preparing the color protection layer paint. Pink dye 1 gram is dissolved in a solvent containing 5 grams of MEK and 4 grams of thermosetting resin.

A flexible polymer based material (1) of dimension 20 cm×26 cm with thickness of 100 μm is prepared. A wire rod of gauge 10# is used to coat a layer of Al luster layer paint on any surface of the flexible polymer based material (1), and then the material is placed within an oven of 100° C. for 2 minute baking so that the surface is hardened. A wire rod of gauge 8# is used to coat the color protection layer paint on the surface opposite to the Al luster layer paint coated surface of the flexible polymer based material (1), and the material is placed within the oven of 100° C. for 2 minute baking so that the surface is hardened.

The resistance of the coating surface of the flexible polymer based material (1) is measured to be 2.6×10¹²Ω which present a non conductive state.

### Embodiment II

An aluminum foil of dimension 2.5 μm×2.5 μm with 0.5 μm thickness, weight 1 gram is used for preparing the metallic lustrous layer paint. The Al foil is placed in a solvent composed of (A) 70 grams MEK (methyl ethyl ketone), (B) 10 grams dispersant with 10 mgKOH/g acid value, (C) 19 grams thermosetting resin and is conducted with high speed stirring (2000 rpm). Finally, 1 wt % of Al luster layer paint is prepared.

Pink dye is used for preparing the color protection layer paint. Pink dye 1 gram is dissolved in a solvent containing 5 grams of MEK and 4 grams of thermosetting resin.

A flexible polymer based material (1) of dimension 2 cm×26 cm with thickness of 100 μm is prepared. A wire rod of gauge 10# is used to coat a layer of Al luster layer paint on any surface of the flexible polymer based material (1), and then the material is placed within an oven of 100° C. for 2 minute baking so that the surface is hardened. Then, a wire rod of gauge 8# is used to coat the color protection layer paint on the Al luster layer paint coated surface of the flexible polymer based material (1), and the material is placed within the oven of 100° C. for 2 minute baking so that the surface is hardened.

The resistance of the coating surface of the flexible polymer based material (1) is measured to be 2.6×10¹²Ω which present a non conductive state.

### Embodiment III

An aluminum foil of dimension 2.5 μm×2.5 μm with 0.5 μm thickness, weight 1 gram is used for preparing the metallic lustrous layer paint. The Al foil is placed in a solvent composed of (A) 70 grams MEK (methyl ethyl ketone), (B) 10 grams dispersant with 10 mgKOH/g acid value, (C) 19 grams thermosetting resin and is conducted with high speed stirring (2000 rpm). Finally, 1 wt % of Al luster layer paint is prepared.

Pink dye is used for preparing the color protection layer paint. Pink dye 1 gram is dissolved in a solvent containing 5 grams of MEK and 4 grams of thermosetting resin.

A flexible polymer based material (1) of dimension 2 cm×26 cm with thickness of 100 μm is prepared. A layer of Al luster layer paint is sprayed on any surface of the flexible polymer based material (1), and then the material is placed within an oven of 100° C. for 2 minute baking so that the surface is hardened. Then, a wire rod of gauge 8# is used to coat the color protection layer paint on the Al luster layer paint coated surface of the flexible polymer based material (1), and the material is placed within the oven of 100° C. for 2 minute baking so that the surface is hardened.

The resistance of the coating surface of the flexible polymer based material (1) is measured to be 2.6×10¹²Ω which present a non conductive state.

### Embodiment IV

An aluminum foil of dimension 2.5 μm×2.5 μm with 0.5 μm thickness, weight 1 gram is used for preparing the metallic lustrous layer paint. The Al foil is placed in a solvent composed of (A) 70 grams MEK (methyl ethyl ketone), (B) 10 grams dispersant with 10 mgKOH/g acid value, (C) 19 grams thermosetting resin and is conducted with high speed stirring (2000 rpm). Finally, 1 wt % of Al luster layer paint is prepared.

Pink dye is used for preparing the color protection layer paint. Pink dye 1 gram is dissolved in a solvent containing 5 grams of MEK and 4 grams of thermosetting resin.

A flexible polymer based material (1) of dimension 20 cm×26 cm with thickness of 100 μm is prepared. A layer of Al luster layer paint is sprayed on any surface of the flexible polymer based material (1), and then the material is placed within an oven of 100° C. for 2 minute baking so that the surface is hardened. Then, a wire rod of gauge 8# is used to coat the color protection layer paint on the surface opposite to the Al luster layer paint coated surface of the flexible polymer based material (1), then the material is placed within the oven of 100° C. for 2 minute baking so that the surface is hardened.

The resistance of the coating surface of the flexible polymer based material (1) is measured to be 2.6×10¹²Ω which present a non conductive state.

Based on the foregoing, the present invention has at least the following advantages.

The manufacturing method of this invention is to form lustrous layer and color protection layer on the flexible polymer based material by coating method. Thus, coating of big dimension under high speed (roll-to-roll) by roller or spay coating method under atmospheric condition is possible so as to achieve economic value of mass production.

The manufacturing method of this invention is to form a lustrous layer on flexible polymer based material by coating, in which the lustrous layer is a film layer having high metallic luster and high impedance. Accordingly, the flexible polymer based material has high impedance, high luster, low metal shielding effect or light-shield capability. In addition, the transmittance of light and electromagnetic wave in demanded range become better so that the interference on the quality of transmission and receiving is avoided.

So far, the abovementioned are merely a part of embodiments of the present invention, which is not restrictive on the scope of the present invention. A variety of variations and modifications made by the person skilled in the art without departing from the spirit and scope of the present invention are still considered to be within the scope of the present invention.

Summing up above, the embodiments of this invention can reach expected effectiveness, and the specific configurations disclosed herein have yet not seen in the prior art of the same category of product, even has not been opened to the public before application.

What is claimed is:

1. A method for making high metallic luster, high impedance on flexible polymer based material, the manufacturing process is listed as below:
step 1: a flexible polymer based material of predetermined dimension is prepared;
step 2: a layer of metallic luster paint is coated on anyone surface of the flexible polymer based material so as to form a lustrous layer;
step 3: on the flexible polymer based material, a color protection layer paint is coated on the surface without coating to form lustrous layer so as to form the color protection layer.

2. A method for making high metallic luster, high impedance on flexible polymer based material according to claim 1, wherein the constituents of said metallic lustrous paint are metal and solvent which is composed of MEK (methyl ethyl ketone), dispersant and thermosetting resin, wherein the solid content of said metal is 1-5 wt %, preferably 1 wt %; the solid content of resin being 15-20 wt %, preferably 19 wt %; the acid value of the dispersant being 10-20 mgKOH/g, preferably 10 mgKOH/g, in weight percentage, the solid content of dispersant being 10-15 wt %, preferably 10 wt %.

3. A method for making high metallic luster, high impedance on flexible polymer based material according to claim 2, wherein said metal is composed of at least one or two kinds selected from Sn, In, Al, Ag, Cu, Cr or the compounds thereof.

4. A method for making high metallic luster, high impedance on flexible polymer based material according to claim 1, wherein said color protection layer paint is formed by MEK (methyl ethyl ketone) and polymers, paint or hardened resin added with coloring matter or matting powder, and wherein the solid content of the coloring matter is 10-15 wt %, preferably 10 wt %; the solid content of the resin being 40-60 wt %, preferably 40 wt %.

5. A method for making high metallic luster, high impedance on flexible polymer based material, the manufacturing process is listed as below:
step 1: a flexible polymer based material of pre-set dimension is prepared;
step 2: a layer of metallic luster paint is coated on anyone surface of the flexible polymer based material so as to form a lustrous layer;
step 3: a color protection layer paint is coated on the lustrous layer so as to form a color protection layer.

6. A method for making high metallic luster, high impedance on flexible polymer based material according to claim 5, wherein the constituents of said metallic lustrous paint are metal and solvent which is composed of MEK (methyl ethyl ketone), dispersant and thermosetting resin, wherein the solid content of said metal is 1-5 wt %, preferably 1 wt %; the solid content of resin being 15-20 wt %, preferably 19 wt %; the acid value of the dispersant being 10-20 mgKOH/g, preferably 10 mgKOH/g, in weight percentage, the solid content of dispersant being 10-15 wt %, preferably 10 wt %.

7. A method for making high metallic luster, high impedance on flexible polymer based material according to claim 6, wherein said metal is composed of at least one or two kinds selected from Sn, In, Al, Ag, Cu, Cr or the compounds thereof.

8. A method for making high metallic luster, high impedance on flexible polymer based material according to claim 5, wherein said color protection layer paint is formed by MEK (methyl ethyl ketone) and polymers, paint or hardened resin added with coloring matter or matting powder, and wherein the solid content of the coloring matter is 10-15 wt %, preferably 10 wt %; the solid content of the resin being 40-60 wt %, preferably 40 wt %.
